(19) United States
(12) Patent Application Publication
(10) Pub. No.: US 2025/0191128 A1
(43) Pub. Date: Jun. 12, 2025

(54) Mixed Latency Video System for Generating Images

(71) Applicant: KARL STORZ Imaging, Inc, Goleta, CA (US)

(72) Inventor: Eric L. Hale, Vancouver, WA (US)

(73) Assignee: KARL STORZ Imaging, Inc, Goleta, CA (US)

(21) Appl. No.: 18/753,311

(22) Filed: Jun. 25, 2024

Related U.S. Application Data
(60) Provisional application No. 63/607,191, filed on Dec. 7, 2023.

(51) Int. Cl. G06T 5/50; G06T 7/20

(52) U.S. Cl. CPC G06T 5/50; G06T 7/20; G06T 2207/20221

(57) ABSTRACT

A video camera for displaying a video image using a mixed latency. In one aspect, the video image is a composite of low-latency and high-latency images, wherein the low-latency images are video images with motion and the high-latency images are video images that are still. In another aspect, the video camera detects a motion in the video image and transmits a low-latency image when the video image includes motion and a high-latency image when the video image is still.

### TECHNICAL FIELD

The disclosure relates to a video system.

### BACKGROUND

Video processing is used for many applications. A video image is captured by a video camera in communication with a processing unit which performs image processing at a predetermined latency. The latency of the image processing may determine in part the quality of the video image, where image quality is defined by the amount of processing that is able to be expended on the received image. The quality of the processed image may result in an output image with a higher resolution (due to, for example, super-resolution processing), greater depth of field, improved dynamic range, enhanced color contrast, noise reduction, blur-correction, etc. Essentially, the term “quality” used throughout this disclosure should be interpreted to mean an improvement to the video image over the originally captured image as a result of some form of image processing. Generally, the higher the latency the greater the possible image quality as the processor is provided more time to apply known processing algorithms, combine information from multiple collected image frames, perform digital filtering, etc., resulting in an output image frame that is of superior quality to that of any single image frame generated at a lower latency. Likewise, the lower the latency the lower the image quality tends to be (relative to a high-latency image) as the image processor is provided with less time to perform image processing to generate the output video image. A high-latency processed image is ideal for capturing video images with very little change between subsequent collected frames, for example capturing bread rising. However, high-latency images may not be ideal for capturing video images with significant amounts of change between subsequent frames, such as when there is quick motion. For instance, a live display of a video of a baseball bat being swung using a high-latency image processing requires more processing time relative to a low-latency image and thus, there are less image frames generated over the same period.

Though use of low-latency image processing at all times would capture more instances of a bay swing relative to high-latency image processing, the quality of the video images of the video stream would not be as great as those generated by high-latency image processing. Further, performing image processing requires extensive computing resources which may not be needed for all portions of a given image or stream of images. Accordingly, it is desirable to have an imaging system which utilizes a mixed latency to improve image quality for portions of an image that require more processing, and reduce processing demands for portions of an image that does not require as much image processing.

### SUMMARY

One aspect of the disclosure provides a video system for processing captured images and displaying a video stream onto a display. The video system includes a means to transmit collected image frames to a processor, which may take the form of a video camera that includes a lens for transmitting optical data to an image sensor and a data processing hardware that is in communication with the image sensor. The video system further includes a memory hardware in communication with the data processing hardware. The memory hardware stores instructions that when executed on the data processing hardware cause the data processing hardware to perform operations to include processing the captured video images, such as those captured by the image sensor of a video camera, to generate a plurality of image frames at different latencies. While this disclosure will in general refer to the captured image frames as being received from a video camera, this is not limiting, and the frames could be captured by any other means known in the art, such as an A/D conversion of an analog video stream, a line-by-line scanning of frames of film, etc. The different latencies include a low-latency and a high-latency resulting in the generation of a low-latency image and a high-latency image. The low-latency image has an image quality lower than an image quality of the high-latency image. The data processing hardware further detects a change in the video images captured by the camera and generates a composite image when a change to one portion of the image is detected. The composite image includes a portion of low-latency image of a first region of the video image and a portion of the high-latency image of a second region of the video image. The first region of the video image includes motion and the second region of the video image is relatively still.

In one aspect of the video camera, when the first region of the video image is still, the composite image is updated by replacing the cropped portion of the low-latency image of the first region of the video image with a high-latency image of the first region of the video. Alternatively, when the first region of the video image is still, the composite image is updated an entirety of the high-latency image.

In one aspect, the high-latency image is generated by processing at least one of the image frames used to generate the low-latency image.

In one aspect, the change is determined by comparing a pair of consecutive image frames. Alternatively, the video camera system may include a motion sensor configured to detect a movement of a tool, wherein the change is the movement of the tool. Alternately or additionally, the video camera may include a motion sensor configured to detect a movement of the camera and/or attached endoscope.

In one aspect, the mixed latencies include a mid-latency, the data processing hardware generating a mid-latency image, the mid-latency image having an image quality greater than the low-latency image and less than the high-latency image. In such an aspect, the change may be one of a first change value and a second change value and the first change value has more change relative to the second change value. Further, in such an aspect, the composite image may further include a portion of the mid-latency generated image of a third region of the video image having the second change value and the portion of the high-latency image of the second region has the first change value. In one aspect, the high-latency image may be generated by processing at least one of the image frames used to generate the mid-latency image.

In yet another aspect of the disclosure a video system for displaying a video stream onto a display using one latency image of a plurality of latencies is provided. The video system includes a video camera with a lens for collecting optical information from an image scene and capturing the optical information with an image sensor and a data processing hardware that is in communication with the image sensor. The video system further includes a memory hardware in communication with the data processing hardware. The memory hardware stores instructions that when executed on the data processing hardware cause the data processing hardware to perform operations including the processing of the images captured by the image sensor to generate a plurality of image frames of mixed latencies, the mixed latencies including a low-latency and a high-latency so as to generate a low-latency image and a high-latency image, wherein the low-latency image has an image quality lower than an image quality of the high-latency image. The data processing hardware further processes a change in the video images capture by the video camera and transmits the high-latency image to the display when the change is within a first predetermined range and transmits the low-latency image to the display when the change is within a second predetermined range, the first predetermined range having less change than the second predetermined range.

In one aspect, wherein the low-latency image may be generated by processing a first predetermined number of image frames and the high-latency image may be generated by processing a second predetermined number of image frames. The second predetermined number of image frames is greater than the first predetermined number of image frames.

In one aspect, the high-latency image may be generated by processing at least one of the image frames used to generate the low-latency image.

In one aspect, the display is a variable refresh rate display, and the data processing hardware instructs the display to refresh the displayed image with the transmission of one of the high-latency image and the low-latency image.

In one aspect, the change may be determined by comparing a pair of consecutive image frames. Alternatively, or in addition to, the video camera may include a motion sensor configured to detect a movement of a tool or the camera, wherein the change is the movement of the tool.

In one aspect, the mixed latency may include a mid-latency and the data processing hardware generates a mid-latency image. The mid-latency image has an image quality greater than the low-latency image and smaller than the high-latency image. In such an aspect, the data processing hardware transmits the mid-latency image to the display when the change is a third predetermined range, the third predetermined range has less change than the second predetermined range and more change than the first predetermined range. The mid-latency image may be generated using at least one image used to generate the low-latency image, and the high-latency image may be generated by processing at least one of the image frames used to generate the mid-latency image.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The embodiments set forth in the drawings are illustrative and exemplary in nature and not intended to limit the subject matter defined by the claims. The patent or application file contains at least one drawing executed in color. Copies of this patent or patent application publication with color drawing(s) will be provided by the Office upon request and payment of the necessary fee. The following description of the illustrative embodiments can be understood when read in conjunction with the following drawings, where like structure is indicated with like reference numerals and in which:

FIG. 1 is a schematic view of a video system according to one or more aspects described herein.

FIG. 2 is a schematic description of the video system including a camera control unit.

FIG. 3A is an illustrative view of a first image frame showing a surgical procedure.

FIG. 3B is an illustrative view of a second image frame of the surgical procedure shown in FIG. 3A.

FIG. 3C is an illustrative view of a composite image frame.

FIG. 4A is an illustrative view of a first image frame showing a surgical procedure.

FIG. 4B an illustrative view of a second image frame of the surgical procedure shown in FIG. 4A wherein the endoscope is bumped between the first frame and the second frames.

FIG. 4C is an illustrative view of a composite image frame taking into account the movement within the scene between the first frame and the second frame.

FIG. 5 is a schematic view of an example computing device that may be used to implement the systems and methods described herein.

FIG. 6 is a method diagram showing the steps of generating a composite image.

FIG. 7 is a method diagram showing the steps of selecting an image based using motion.

### DETAILED DESCRIPTION OF PREFERRED EMBODIMENTS

Implementations herein are directed toward a video system having a video camera, the video system displaying a video stream using images of mixed latencies so as to improve processing efficiency while providing higher quality image frames than would be possible with low latency image frames alone. In one aspect of the disclosure, the video image is a composite of a low-latency image of a portion of an image with little change and a high-latency image of a portion of the image with a predetermined amount of change. In another aspect, the video camera transmits a low-latency image to the display or a high-latency image to the display based upon the change detected in subsequent images. In such an aspect, the video camera may be further configured to instruct a variable refresh rate display to generate a refresh rate that is synchronized with the transmission of the selected low-latency or high-latency image.

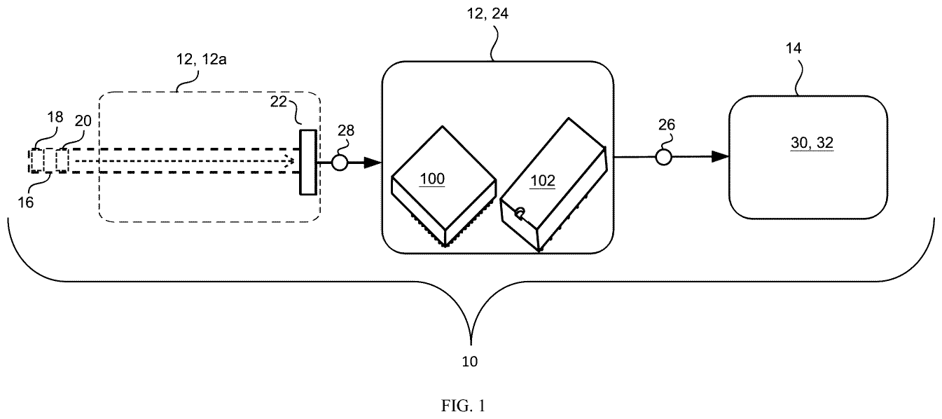

With reference now to FIG. 1, a schematic depiction of a video imaging and display system 10 is provided. For illustrative purposes, the video imaging and display system 10 is discussed in the context of a surgical procedure, but it should be appreciated that the system 10 may be used in and for other applications. The system 10 includes a video camera 12 (or other image capture and generation device) and a display 14. For illustrative purposes, the video camera 12 is shown as a camera head unit 12a that is coupled to an endoscope 16. In one aspect, the endoscope 16 is detachably coupled to the camera head unit 12a. The endoscope 16 includes an objective lens group 18 for collecting and focusing an image light from a scene under observation. In some aspects, the endoscope may further include a relay lens group 20 configured to relay optical data (e.g., light collected by the objective lens) from the objective lens group 18 to an image sensor 22 contained within the camera head unit 12a. The camera head unit 12a is electronically coupled to a camera control unit (CCU) 24 and the camera control unit 24 is coupled to the display 14, such as a monitor. The camera control unit 24 includes a data processing hardware 100 which executes instructions or programs stored on a memory hardware 102 for processing an electric signal from the image sensor 22 into an image frame 26 which is transmitted to the display 14 for view. It should be noted that the CCU (24) may be an element of the camera 12 or camera head 12a.

It should be appreciated that the video camera 12 may be a video endoscope (not shown) which includes the objective lens group 18, the image sensor 22, and may include data processing hardware 100 and the memory hardware 102, or, alternatively, the video endoscope maybe connected to a camera control unit 24 including the data processing hardware 100 and the memory hardware 102. Alternatively, the video camera may be a camera head 12a connected to a detachable endoscope 16 as described in the previous paragraph. As such it is appreciated that the term “video camera 12” is not limited to a particular device, but a device with the ability to capture images and transmit the data to processing hardware 100 and memory hardware 102 described herein, or, alternatively, the video camera 12 may include one or both of the data processing hardware 100 and memory hardware 102. In one aspect, the image sensor 22 may be a complementary metal oxide semiconductor (CMOS) or a Charged Coupled Device (CCD). It should be appreciated that any pixelated image sensor 22 currently known or later developed may be modified and adopted for use herein.

With reference again to FIG. 1, the video camera 12 is configured to capture image data using an image sensor 22 to generate a plurality of image frames 26 which may be compiled together to form an output frame 26 displayed as a video image 30 on a display 14. As shown in FIG. 1, optical data in the form of light is transmitted from an objective lens group 18 to the image sensor 22. The image sensor 22 processes the light into an image frame 26 in the form of an electric signal which is processed by the data processing hardware 100 disposed in the camera control unit 24. The camera control unit 24 includes the memory hardware 102 which stores instructions executable by the data processing hardware 100 which not only generates an output frame 26 but also performs image processing such as frame optimization, improved dynamic range, noise reduction, bandwidth filtering, edge detection and the like. The output frames 26 are transmitted to the display 14 in the form of the video image 30.

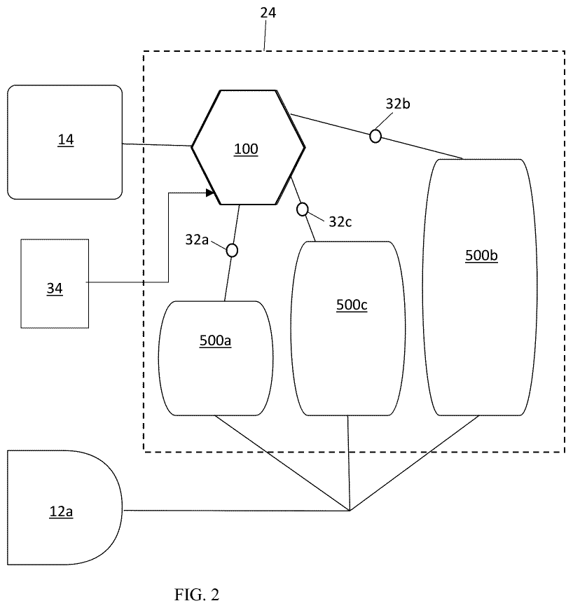

With reference now to FIG. 2, a schematic depiction of the camera control unit 24 is provided. The data processing hardware 100 and the memory hardware 102 are illustratively shown as being disposed in the camera control unit 24, however, it should be appreciated that the data processing hardware 100 and the memory hardware 102 may be elements of the camera system 12, be disposed on a remote server (not shown) in communication with the camera 12 or camera control unit 24 or be integrated within the camera head unit 12a. The data processing hardware 100 processes the image frames 26 to generate a plurality of output frames 26 in a video stream where the individual frames may be generated at a mixed latency or a combination of latencies. As used herein the term “latency” refers to the time given for the data processing hardware 100 to process the image frame or frames 26, generate an output frame 26, perform image processing, and/or transmit the video image 30 to the display 14. The mixed latency 500 includes a low-latency processing routine 500a and a high-latency processing routine 500b so as to generate a low-latency image 32a and a high-latency image 32b. The term “high-latency” refers to an imaging process routine which is given more time to process the image data 28 to generate an output frame 26 to be transmitted to the display 14, relative to a “low-latency” image.

It should be appreciated that the latency may be related to a frame rate but is not necessarily tied to the frame rate, i.e., the number of frames to be displayed per second. For instance, a camera control unit 24 may have the ability to generate up to 60 frames per second, however, the low-latency processing routine 500a may be set at .1 second, in which case, ten (10) collected image frames 26 may be processed to generate a single low-latency image 32a. The high-latency processing routine 500b, by contrast, may be set at .5 seconds, in which case thirty (30) image frames 28 may be processed to generate a single high-latency image 32b. Alternatively, for example, the high-latency processing routine 500b may process ten (10) image frames 26 but perform more image processing on those ten (10) image frames 26 relative to the low-latency processing routine 500a. Further, the low-latency images 32a have less time for image processing relative to high-latency images 32b, and thus the high-latency images 32b may contain more collected image frames 26, and thus more image data 28 relative to the low-latency images 32a. As the low-latency images 32a may have fewer collected image frames 26, and thus less image data 28 and less processing time relative to high-latency images 32b, the low-latency images 32a have an image quality lower than an image quality of the high-latency images 32b.

The camera control unit 24 further detects a change in the video images 28 collected by the video camera 12 and generates a composite image 32. In one aspect, the composite image 32 may be a predetermined composition wherein the area of the video image 30 for which the high-latency images 32b and the low-latency images 32a occupy are set. For instance, the low-latency image 32a may be centered within the image frame 26 and the high-latency image 32b may surround the periphery of the low-latency image 32a. In another aspect of a predetermined composition, a tool 36 may be a high-latency image 32b and the tissue may be a low-latency image 32a.

In another aspect, the composite image 32 may be generated when a change is detected. The change may be determined digitally by image processing. As used herein, the term “change” refers to a difference in the scene under observation as a result of an object within the scene moving or other differences in pixel data which occur from one frame to the next, such as a change in color, lighting, or contents of the image, including the introduction or movement of a tool within the scene. The camera control unit 24 may be configured to determine a change by comparing a pair of consecutive collected image frames 26 wherein a change is determined if the collected image data 28 from a first image frame 26 is different than the image data 28 of a second image frame 26. For instance, through image processing, the camera control unit 24 may determine that a heart is beating by an expansion and contraction of the heart as viewed through successive image frames 26. Additionally, the video camera 12 may include a motion sensor 34 configured to detect a movement of the camera and/or an attached endoscope. Further motion of a tool 36 used in the surgical procedure and within the captured scene may include an inertial measurement unit for detecting movement of the tool 36.

The camera control unit 24 processes the detected change to generate a composite image 32 including portions of a low-latency image 32a and portions of a high-latency image 32b. In particular, the composite image 32 includes a cropped portion representing a first region (A1) of the low-latency image 32a and a cropped portion representing a second region (A2) of the high-latency image. The first region (A1) of the video image 30 is the region of the image in which a predetermined amount of change is detected. The resultant composite image 32 is stitched together from the cropped first region A1 and the cropped second region A2 of the respective latency images and represents a complete image of the scene under observation.

The camera control unit 24 may be configured to transmit an output frame 26 to the display 14 using one of the frames produced by a low-latency processing routine 500a and a high-latency processing routine 500b. During image processing, image data 28 from consecutively collected image frames 26 is compared to determine a change in the incoming images, wherein if the difference in the image data 28 from the collected image frames 26 reaches a predetermined threshold, the camera control unit 24 generates the composite image 32 as described above. In such an aspect, the regions of the collected image frames 28 which have the same image or in which the difference in the image data is below the predetermined threshold are processed using the high-latency processing routine 500b, as such images are relatively unchanged. Concurrently, the regions of the image frames 26 which have different image data and the difference between the image frames 26 is above the predetermined threshold are processed using the low-latency processing routine 500a.

In one aspect of the video system 10, when the first area (A1) of the video image 30 is still or little change is detected between subsequent frames, the composite image 32 may be updated by replacing the cropped portion (A1) of the low-latency image 32a with a high-latency image 32b of the first area (A1). Thus, composite image 32 is a single image made of images from image frames 26 generated using a low-latency process and images generated using a high-latency process. For example, regions of the image which have movement between subsequent frames are displayed using a low-latency process and regions of the image which are still are displayed using a high-latency process. Alternatively, when the first area (A1) of the video image is still, the composite image 32 is updated and is composed entirely of the high-latency image 32b.

The high-latency image 32b may be generated by processing at least one of the image frames 26 used to generate the low-latency image 32a. For example, the image sensor 22 may be configured to read out or transfer data at a rate that is faster than the rate of the low-latency processing routine 500a, wherein each read out correlates to an image frame 26. Thus, in a low-latency processing routine 500a the camera control unit 24 may process five image frames 28 to generate an image frame 26 to be transmitted to the display 14. These same five image frames 28 may be also processed in addition to the next ten image frames 28 during a high-latency processing routine 500b to generate an image frame 26 for transmission to the display 14.

The camera control unit 24 may be further configured to process an image frame 26 at a mid-latency processing routine 500c to generate a mid-latency image. The mid-latency processing routine 500c has a processing time greater than the low-latency processing routine 500a and less than the high-latency processing routine 500b, and thus has an image quality greater than the low-latency image 32a and less than the high-latency image 32b. In such an aspect, the camera control unit 24 is configured to process a mid-latency image 32c at the mid-latency processing routine 500c for regions of the image which have less change than the region of the image processed at the high-latency processing speed. For example, the change may be one of a first change value and a second change value and the first change value has more change relative to the second change value and areas of the image having a first change value are processed at a high-latency processing routine 500b while the areas of the image having a second change value are processed at a mid-latency processing routine 500c. In aspects where the camera control unit 24 operates at a mid-latency processing routine 500c, the composite image 32 may include a cropped portion of the mid-latency image 32c of a third region (A3) of the video image 30 having the second change value and the cropped portion of the high-latency image 32b of the second region (A2) has the first change value. In one aspect, the high-latency image 32b may be generated by processing at least one of the image frames 26 used to generate the mid-latency image 32c.

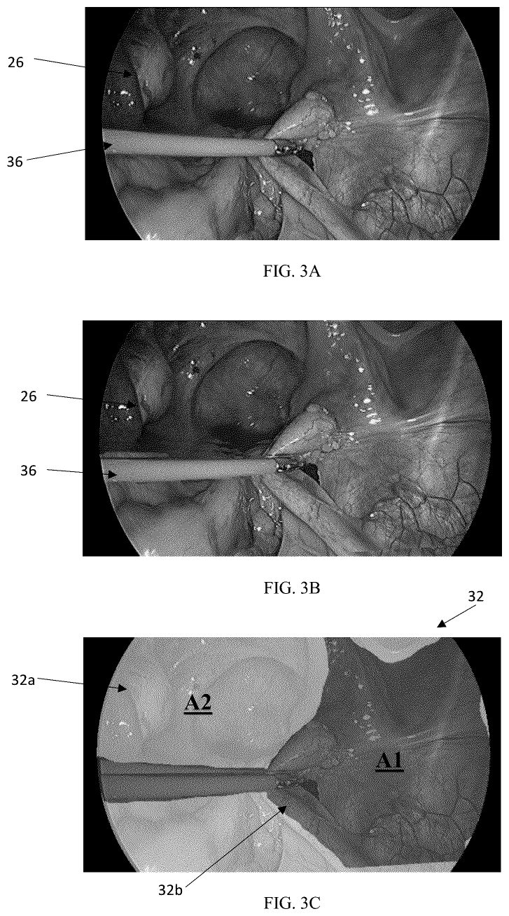

With reference now to FIGS. 3A-3C, an operation of a video imaging system 10 is provided wherein the video camera system 12 is a video endoscope having a camera control unit 24. With reference first to FIG. 3A a tool 36 is shown grasping a portion of tissue. In FIG. 3B, the tool 36 is moved and pulls the tissue causing the tissue to the right of the tool 36 (the first region (A1 of FIG. 3C)) to move to the left, but the remaining tissue in the image frame 26 (the second area (A2 of FIG. 3C)) remains relatively still. The camera control unit 24 processes the two image frames 26 shown in FIGS. 3A and 3B to determine if a change has occurred in the two image frames 26. In this example, the change is a movement of tissue and a tool 36. In other aspects, the change may be a change in pixel intensity or light. Assuming in this case that the determined change exceeds a predetermined threshold, the camera control unit 24 generates a composite image 32 shown in FIG. 3C wherein the first area (A1) is made using portions of a low-latency image 32a and the second region (A2) is made using portions of a high-latency image 32b. In particular, the first region (A1) is a low-latency image 32a generated by a low-latency processing routine 500a and the second region (A2) is a high-latency image 32b generated by a high-latency processing routine 500b and the two regions are stitched together by image processing into resultant image 32. It should be appreciated that the low-latency image 32a is the image frame 26 to be transmitted to the display 14 and may be generated by processing more than one image frame 26 from the image sensor 22. Likewise, the high-latency image 32b is also an image frame 26 to be transmitted to the display 14 and may be generated by processing more than one image frame 26 from the image sensor 22 to include the image data 28 used to generate the low-latency image 32a. The low-latency image 32a is processed at a low-latency processing routine 500a and high-latency image 32b is processed at a high-latency processing routine 500b and thus the low-latency image 32a is processed in less time and may use fewer image frames 26 relative to the high-latency image 32b. The camera control unit 24 crops the first region (A1) from low-latency image 32a and replaces that corresponding region in the high-latency image 32b so as to generate the composite image 32.

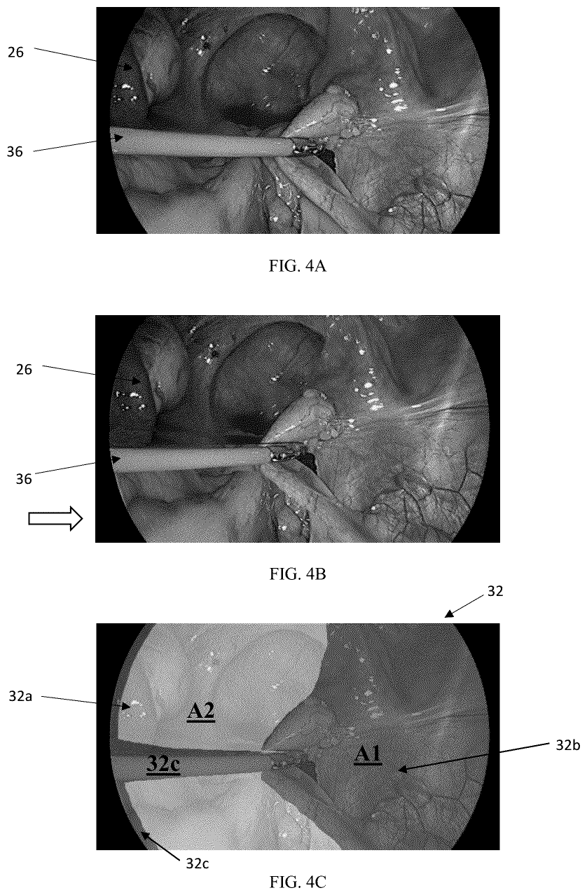

With reference now to FIGS. 4A-4C, in another aspect of the video imaging system 10, where the tool 36 pulls the tissue and the video endoscope 12 is bumped, as indicated by the arrow outline shown in FIG. 4B. FIG. 4A shows a first state where the tool 36 grabs tissue. FIG. 4B shows a state where the tool 36 pulls the tissue causing the tissue to the right of the tool 36 (the first region (A1 of FIG. 4C)) to move but the remaining tissue in the image frame 26 (the second region (A2 of FIG. 4C)) remains still. Additionally, the video endoscope is bumped to the right relative to FIG. 4A and the scene is shifted, in the subsequent frame, to the right as shown in FIG. 4B. Thus, although the image data 26 between the image shown in FIG. 4A is different than the image data 28 of the image shown in FIG. 4B, on a pixel-by-pixel basis a majority of the actual image is the same but translated to the right as a result of the video camera 12 being bumped. FIG. 4C depicts an aspect where the camera control unit 24 is configured to account for the translation of the image data 26 between the captured frames. Thus, a central region of the image from FIG. 4A to FIG. 4B is the same but is simply translated to the right. In such a case, the camera control unit 24 processes the translation (e.g., the second region (A2)) using a high-latency process as determining that tissue in the second region (A2) has not changed but that the view has is merely translated to the right. The area to the right of the tool 36 that is actually moved is processed using a low-latency process and the composite image 32 is generated by cropping the first region (A1) from low-latency image 32a and combining it with the region (A2) from the high-latency image 32b so as to generate the composite image 32 displaying the entire scene under observation. In one aspect, the area bounding the left side of the image that is shifted and the tool 36 may be processed using a mid-latency processing routine 500c, so as to generate a mid-latency image 32c, however as the image data is new relative to the image data of the previous frame, this region may also be supplied by the low-latency image 32a.

With reference again to FIGS. 1 and 2, a video system 10 for displaying a video image 30 onto a display 14 using one latency image of a plurality of latencies is provided. The video camera 12 is configured to process data from an image sensor 22 that receives optical data from a lens, such as an objective lens group 18. As described above, the video camera 12 may be video endoscope, a borescope, or exoscope, but is not limited to a particular device.

In some aspects, the video camera 12 is a camera head unit 12a, and the data processing hardware 100 is disposed in a camera control unit 24 that is in communication with the image sensor 22 disposed in the camera head unit 12a. The video system 10 further includes a memory hardware 102 in communication with the data processing hardware 100. The memory hardware 102 stores instructions that when executed on the data processing hardware 100 cause the data processing hardware 100 to perform operations to include processing the video image 30 captured by the image sensor 22 to generate a plurality of image frames 26 at a mixed latency.

The camera control unit 24 performs image processing at multiple latencies, including a low-latency processing routine 500a and a high-latency processing routine 500b so as to generate a corresponding low-latency image 32a and a high-latency image 32b. The image frames 26 may be processed at different latencies concurrently. In one aspect, image data 28 transmitted from the image sensor 22 is processed to generate a low-latency image 32a, and the low-latency image 32a may be further processed as part of the high-latency processing routine 500b with additional image data 28 to generate a high-latency image 32b. The low-latency image 32a has an image quality lower than an image quality of the high-latency image 32b as the amount of image data 28 and the amount of processing available is less than the high-latency image 32b.

The camera control unit 24 is further configured to detect a change in the image frames 26 and/or video image 30 captured by the video camera 12 to determine what type of image to display, i.e., a low-latency image 32a or a high-latency image 32b. The camera control unit 24 transmits the high-latency image 32b to the display 14 when the change is within a first predetermined range and transmits the low-latency image 32a to the display 14 when the change is within a second predetermined range, the first predetermined range having less change than the second predetermined range. In one aspect, the first predetermined range is a still image and the second predetermined range is any detected change.

The low-latency image 32a may be generated by processing a first predetermined number of image frames 26 and the high-latency image 32b may be generated by processing a second predetermined number of image frames 26. The second predetermined number of image frames 26 is greater than the first predetermined number of image frames 26. For instance, an image sensor 22 may generate 120 image frames 26 per second, but the refresh rate of the display 14, e.g., the number of times per second that the images refreshes on the display 14 may be 60 Hz, or 60 refreshes per second. In which case, the low-latency image 32a may be generated by processing five (5) image frames 26 and the high-latency image 32b may be generated by processing twenty (20) frames per second, e.g., to match the refresh rate of the display 14 wherein the high-latency image 32b is processed using the same image frames 26 used to process the low-latency image 32a. The camera control unit 24 may have a single processor to perform the image processing or may include different processors for each latency.

In one aspect, the display 14 is a variable refresh rate display and the camera control unit 24 instructs the display 14 to refresh the displayed image at a rate that is synchronized with the transmission of one of either the high-latency image 32b or the low-latency image 32a. For instance, if the camera control unit 24 makes a determination to transmit a high-latency image 32b at a rate of 60 frames per second, the camera control unit 24 instructs the display 14 to refresh at 60 frames per second. Alternatively, if the camera control unit 24 makes a determination to transmit a low-latency image 32a at a rate of 120 frames per second, the camera control unit 24 instructs the display 14 to refresh at a rate of 120 frames per second. In one aspect, the camera control unit 24 transmits a signal to the display 14 unit to refresh the display 14 when the high-latency image 32b or the low-latency image 32a is transmitted to the display 14. It should be appreciated that in instances where the camera control unit 24 makes a determination to transmit a composite image 32, the camera control unit 24 instructs the display 14 to refresh at the highest latency. For example, if the composite image 32 includes a portion of the low-latency image 32a and a mid-latency image 32c, the camera control unit 24 instructs the display 14 to refresh at a rate that is the same as the processing routine 500c of the mid-latency image 32c.

The decision as to whether to send a high-latency image or a low-latency image is determined by the CCU by comparing a pair of consecutive image frames 26 using image processing techniques currently known and later developed. For instance, the image frames 26 may be processed by comparing image data 28 on a pixel-by-pixel basis of consecutive image frames 26. Alternatively, or in addition to, the video camera 12 may include a motion sensor 34 configured to detect a movement of a tool 36, wherein the change is the movement of the tool 36 or of the video camera 12. In the context of a surgical procedure, the tool 36 may be a clamp, scissors, or the like.

It should be appreciated that the camera control unit 24 may be configured to process image data 28 using more than two different latencies. For instance, the camera control unit 24 may be configured to process image data 28 at a mid-latency processing routine 500c to generate a mid-latency image 32c. The mid-latency image 32c has an image quality greater than the low-latency image 32a and less than the high-latency image 32b. In such an aspect, the camera control unit 24 transmits the mid-latency image 32c to the display 14 when the change is a third predetermined range having has less change than the second predetermined range and more change than the first predetermined range. For instance, a beating heart may have sufficient motion to meet the second predetermined range as the muscles of the heart expand and contract anywhere between 60 to 100 times a minute, whereas pulling a tissue as part of a surgical procedure may have sufficient motion to meet the third predetermined range as pulling the tissue may not generate quicker movement or result in a greater change in the physical shape of the tissue relative to a beating heart. The mid-latency image 32c may be generated using at least one image used to generate the low-latency image 32a, and the high-latency image 32b may be generated by processing at least one of the image frames 26 used to generate the mid-latency image 32c. It should be appreciated that the camera control unit 24 may be configured to process image data 28 at additional latencies other than what is specifically described herein.

In operation, the camera control unit 24 processes image data 26 to determine which of the latencies to use based upon the amount of change determined through image processing. At a default setting, the camera control unit 24 may be configured to automatically transmit a low-latency image 32a and automatically transmit a high-latency image 32b when sufficient image data 26 is available. The camera control unit 24 continuously processes image data 28 and compares image frames to determine if a change has occurred, assuming that no change has occurred, high-latency images 32b generated by the high-latency process routine is transmitted to the display 14. However, should change occur, the camera control unit 24 performs a low-latency processing routine 500a and transmits a low-latency image 32a to the display 14. In cases, where the display 14 is a variable refresh rate display, the camera control unit 24 may be further configured to transmit an instruction to the display 14 to refresh the image commensurate with the timing of the appropriate latency image, i.e., if change has occurred to refresh the image with a low latency image and if change has not occurred to either not refresh the display 14 or to refresh when a high-latency image is available.

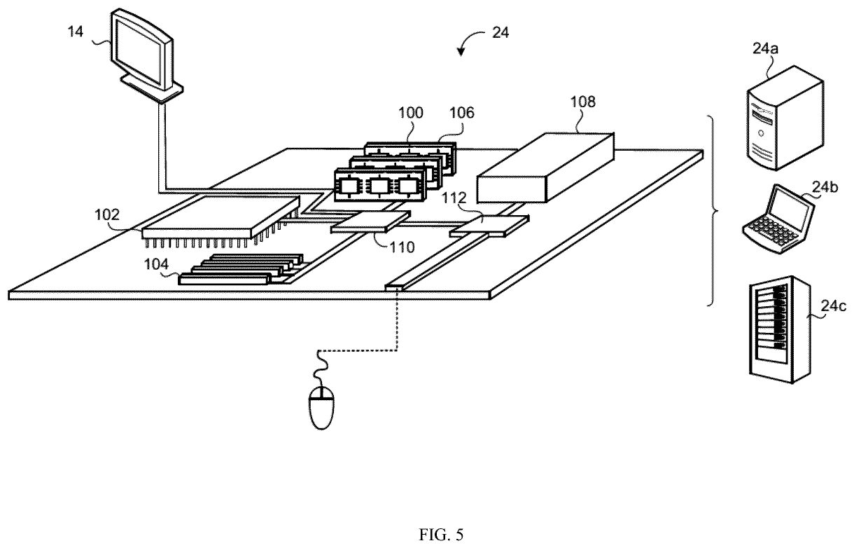

FIG. 5 is schematic view of an example camera control unit 24 (e.g., data processing hardware 100 and memory hardware 102) that may be used to implement the systems and methods described in this document. For examples, camera control unit 24 may perform tasks such as controlling a light source (e.g., enabling and disabling the light source, switching between white light and NIR light, etc.), configuring and communicating with the image sensor 22 (e.g., receiving the image data 28), and implementing and executing one or more of the digital filters 104. In some examples, the camera control unit 24 transmits image data 28 to the display 14. That is, using the data received from the image sensors 22, the camera control unit 24 may store and execute instructions or operations to implement any number of imaging processing routines currently known and later developed for performing known tasks such as high dynamic range (HDR) imaging, improved depth of field rendering, noise reduction, edge detection and the like. The camera control unit 24 is intended to represent various forms of digital computers 24a, such as laptops 24a, desktops 24b, workstations (not shown), personal digital assistants (not shown), servers (not shown), blade servers (not shown), mainframes 24c, and other appropriate computers. The components shown here, their connections and relationships, and their functions, are meant to be exemplary only, and are not meant to limit implementations of the disclosures described and/or claimed in this document.

The camera control unit 24 (e.g., data processing hardware 100) includes a processor 106, memory hardware 102, a storage device 108, and a high-speed interface/controller 110 connecting to the memory hardware 102. Each of the components 100, 102, 104, 106, 108, and 110, are interconnected using various busses, and may be mounted on a common motherboard or in other manners as appropriate. The processor 106 can process instructions for execution within the camera control unit 24, including instructions stored in the memory hardware 102 or on the storage device 108 to display graphical information for a graphical user interface (GUI) on an external input/output device, such as display 14 coupled to high-speed interface 110. In other implementations, multiple processors and/or multiple buses may be used, as appropriate, along with multiple memories and types of memory. Also, multiple camera control units 24, 24a, 24b, 24c may be connected, with each device providing portions of the necessary operations (e.g., as a server bank, a group of blade servers, or a multi-processor system).

The memory hardware 102 stores information non-transitorily within the camera control unit 24. The memory hardware 102 may be a computer-readable medium, a volatile memory unit(s), or non-volatile memory unit(s). The non-transitory memory hardware 102 May be physical devices used to store programs (e.g., sequences of instructions) or data (e.g., program state information) on a temporary or permanent basis for use by the camera control unit 24. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 108 is capable of providing mass storage for the camera control unit 24. In some implementations, the storage device 108 is a computer-readable medium. In various different implementations, the storage device 108 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory hardware 102, the storage device 108, or memory on processor 106.

The high-speed controller 110 manages bandwidth-intensive operations for the camera control unit 24, while a low-speed controller 112 manages lower bandwidth-intensive operations. Such allocation of duties is exemplary only. In some implementations, the high-speed controller 110 is coupled to the memory hardware 102, the display 14 (e.g., through a graphics processor or accelerator), and to a high-speed expansion port (not shown), which may accept various expansion cards (not shown). In some implementations, the low-speed controller 112 is coupled to the storage device 108 and a low-speed expansion port (not shown). The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The camera control unit 24 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware 100, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

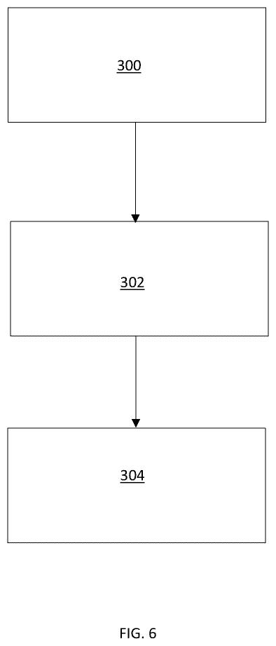

With reference now to FIG. 6 a method of generating a video image 30 onto a display 14 is provided. The method is executed by a video camera 12 that receives image data 28 from an image sensor 22 and begins at block 300 where image frames 26 are processed at a mixed latency, the mixed latency including a low-latency and a high-latency so as to generate a low-latency image 32a and a high-latency image 32b, wherein the low-latency image 32a has an image quality lower than an image quality of the high-latency image 32b but requires less processing time relative to the high-latency image 32b. At block 302, image data 28 in consecutive image frames 26 are processed to determine if a change occurs. The change may be determined by comparing a pair of consecutive image frames 26. A motion sensor 34 may be used to detect a movement of a tool 36 or the camera 12 and the movement may be processed by the camera control unit 24 for image processing as described below.

At block 304, a composite image 32 is generated when a change is detected. The composite image 32 includes a cropped portion of low-latency image 32a of a first area (A1) of the video image 30, the first area (A1) having change and a portion of the high-latency image 32b of a second area (A2) of the video image 30, the second area (A2) of the video image 30 being still. In one aspect, the change may be a movement of a tool 36 and the image of the tool 36 is processed at the low-latency.

In the method, when the first area (A1) of the video image 30 is still, the composite image 32 is updated by replacing the cropped portion of the low-latency image 32a of the first area (A1) of the video image 30 with a high-latency image 32b of the first area (A1) of the video that is still. Alternatively, when the first area (A1) of the video image 30 is still, the composite image 32 is updated an entirety of the high-latency image 32b.

In one aspect of the method, the mixed latency includes a mid-latency, the data processing hardware 100 generating a mid-latency image 32c, the mid-latency image 32c having an image quality greater than the low-latency image 32a and less than the high-latency image 32b. The high-latency image 32b may be generated by processing at least one of the image frames 26 used to generate the low-latency image 32a. The high-latency image 32b may be generated by processing at least one of the image frames 26 used to generate the mid-latency image 32c. In such an aspect, the change is one of a first change value and a second change value, the first change value having more change relative to the second change value; and the composite image 32 further includes a cropped portion of the mid-latency image 32c of a third area (A3) of the video image 30 having the first change value and the cropped portion of the high-latency image 32b of the second area (A2) has the second change value.

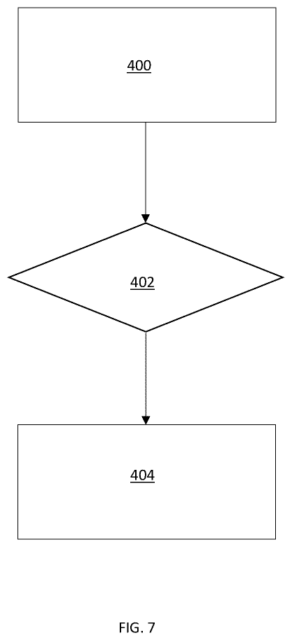

With reference now to FIG. 7, a method for generating a generating a video image 30 onto a display 14 is provided. The method is executed by a video camera 12 that receives image data 28 from an image sensor 22 and begins at block 400 where image data 28 captured by the image sensor 22 generates a plurality of image frames 26 at a mixed latency including a low-latency and a high-latency so as to generate a low-latency image 32a and a high-latency image 32b. The low-latency image 32a has an image quality smaller than an image quality of the high-latency image 32b.

The method proceeds to block 402 where it is determined if a change exists in the image data 28. The change may be determined by comparing a pair of consecutive image frames 26. A motion sensor 34 may be used to detect a movement of a tool 36 and the movement may be processed by the camera control unit 24 for image processing as described below.

At block 404, the method transmits a high-latency image 32b when the change is within a first predetermined range and at block 406 the method transmits a low-latency image 32a when the change is within a second predetermined range. The first predetermined range having less change than the second predetermined range. The low-latency image 32a may be generated by processing a first predetermined number of image frames 26 and the high-latency image 32b may be generated by processing a second predetermined number of image frames 26, the second predetermined number of image frames 26 greater than the first predetermined number of image frames 26. The high-latency image 32b may be generated by processing at least one of the image frames 26 used to generate the low-latency image 32a.

In one aspect of the method, the method may include generating a mid-latency image 32c. The mid-latency image 32c has an image quality greater than the low-latency image 32a and less than the high-latency image 32b. In such an aspect, the mid-latency image 32c is transmitted to the display 14 when the change is a third predetermined range, the third predetermined range has less change than the second predetermined range and more change than the first predetermined range. The mid-latency image 32c may be generated using at least one image used to generate the low-latency image 32a and the high-latency image 32b may be generated by processing at least one of the image frames 26 used to generate the mid-latency image 32c.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A video camera for displaying a video image onto a display, the video camera comprising:
a lens for transmitting optical data to an image sensor;
data processing hardware in communication with the image sensor; and
memory hardware in communication with the data processing hardware, the memory hardware storing instructions that when executed on the data processing hardware cause the data processing hardware to perform operations comprising:
processing the video image captured by the image sensor to generate a plurality of image frames at a mixed latency, the mixed latency including a low-latency and a high-latency so as to generate a low-latency image and a high-latency image, wherein the low-latency image has an image resolution smaller than an image resolution of the high-latency image;
processing a motion in the video image capture by the video camera; and
generating a composite image when a motion is detected, wherein the composite image includes a cropped portion of low-latency image of a first area of the video image, the first area having motion and a portion of the high-latency image of a second area of the video image, the second area of the video image being still.

2. The video camera of claim 1, wherein when the first area of the video image is still, the composite image is updated by replacing the cropped portion of the low-latency image of the first area of the video image with a high-latency image of the first area of the video that is still.

3. The video camera of claim 1, wherein when the first area of the video image is still, the composite image is updated an entirety of the high-latency image.

4. The video camera of claim 1, wherein the low-latency image is generated by processing at least one of the image frames used to generate the high-latency image.

5. The video camera of claim 1, wherein the motion is determined by comparing a pair of consecutive image frames.

6. The video camera of claim 1, further including a motion sensor configured to detect a movement of a tool, wherein the motion is the movement of the tool.

7. The video camera of claim 1, wherein the high-latency image is generated by processing at least one of the image frames used to generate the mid-latency image.

8. The video camera of claim 1, wherein the mixed latency includes a mid-latency, the data processing hardware generating a mid-latency image, the mid-latency image having an image resolution greater than the low-latency image and less than the high-latency image.

9. The video camera of claim 8, wherein the motion is one of a first movement value and a second movement value, the first movement value having more motion relative to the second movement value.

10. The video camera of claim 9, wherein the composite image further includes a cropped portion of the mid-latency image of a third area of the video image having the second movement value and the cropped portion of the high-latency image of the second area has the first movement value.

11. A video camera for displaying a video image onto a display, the video camera comprising:
a lens for transmitting optical data to an image sensor;
data processing hardware in communication with the image sensor; and
memory hardware in communication with the data processing hardware, the memory hardware storing instructions that when executed on the data processing hardware cause the data processing hardware to perform operations comprising:
processing the video image captured by the image sensor to generate a plurality of image frames at a mixed latency, the mixed latency including a low-latency and a high-latency so as to generate a low-latency image and a high-latency image, wherein the low-latency image has an image resolution smaller than an image resolution of the high-latency image;
processing a change in the video image capture by the video camera; and
transmitting the high-latency image when the change is within a first predetermined range and transmitting the low-latency image when the change is within a second predetermined range, the first predetermined range having less change than the second predetermined range.

12. The video camera of claim 11, wherein the low-latency image is generated by processing a first predetermined number of image frames.

13. The video camera of claim 12, wherein the high-latency image is generated by processing a second predetermined number of image frames, the second predetermined number of image frames greater than the first predetermined number of image frames.

14. The video camera of claim 13, wherein the high-latency image is generated by processing at least one of the image frames used to generate the low-latency image.

15. The video camera of claim 11, wherein the change is a motion is determined by comparing a pair of consecutive image frames.

16. The video camera of claim 11, wherein the change is determined by comparing a pair of consecutive image frames.

17. The video camera of claim 11, further including a motion sensor configured to detect a movement of a tool, wherein the change is the movement of the tool.

18. The video camera of claim 17, wherein the mixed latency includes a mid-latency, the data processing hardware generating a mid-latency image, the mid-latency image having an image resolution greater than the low-latency image and less than the high-latency image.

19. The video camera of claim 18, wherein the data processing hardware transmits the mid-latency image when the motion is a third predetermined range, the third predetermined range has less motion than the second predetermined range and more motion than the first predetermined range.

20. The video camera of claim 19, wherein the mid-latency image is generated using at least one image used to generate the low-latency image and the high-latency image is generated by processing at least one of the image frames used to generate the mid-latency image.
